(19) United States
(12) Patent Application Publication
(10) Pub. No.: US 2019/0023946 A1
(43) Pub. Date: Jan. 24, 2019

(54) THREE-DIMENSIONAL SHEET FOR PROTECTION OF ELECTRONIC DEVICE

(71) Applicant: GAONNURI CO.,LTD., Gumi-si (KR)

(72) Inventor: Do Kyung KIM, Gumi-si (KR)

(21) Appl. No.: 15/681,757

(22) Filed: Aug. 21, 2017

(30) Foreign Application Priority Data
Jul. 20, 2017 (KR) 10-2017-0092197

(51) Int. Cl. C09J 7/02; B32B 27/08; B32B 27/30; B32B 7/12

(52) U.S. Cl. CPC C09J 7/0282; B32B 27/08; C09J 2201/162; B32B 7/12; B32B 2457/00; B32B 27/308

(57) ABSTRACT

Disclosed herein is a three-dimensional (3D) sheet configured to be attached to the screen of an electronic device and a border portion surrounding the screen. The 3D sheet includes: an adhesive layer configured to be attached to the screen and border portion of the electronic device so that the adhesive layer covers 90% or more of the overall area of the front surface of the electronic device; and a cover sheet configured to be attached to the adhesive layer. The adhesive layer includes an OCA layer, a PET film layer, and a silicon adhesive layer. The 3D sheet is closely attached to the screen and border portion of the electronic device.

### BACKGROUND

### 1. Technical Field

The present disclosure relates generally to a three-dimensional (3D) sheet for the protection of an electronic device. More specifically, the present disclosure relates to an improved 3D sheet for the protection of an electronic device, which is closely attached to the overall surface of an electronic device, such as a smartphone, and can maintain the intrinsic color and high-level design of the electronic device without change.

### 2. Description of the Related Art

There have been developed sheets for protecting the liquid crystal panels of electronic devices, such as smartphones.

A two-dimensional (2D) transparent sheet 1′ for the protection of a liquid crystal display has been developed as a first-generation sheet product for the protection of a liquid crystal display. For example, as shown in FIG. 1(a), this sheet 1′ is attached to the liquid crystal screen D of a smartphone H. The sheet 1′ includes an adhesive layer 1a′ and a cover sheet 1b,′ as shown in FIG. 1(b). The adhesive layer 1a′ is attached to the smartphone H. In the views below FIG. 1(b), a boundary line v indicates the boundary of the screen region of the smartphone H when viewed from a side of the smartphone H.

Meanwhile, the width of the sheet 1′ is formed to be narrower than that of the screen D, and the sheet 1′ does not cover the corners and edge portions of the smartphone H. Accordingly, problems arise in that there are screen portions D′ which are not covered by the sheet 1,′ and the curved rounded portions R of the smartphone H are exposed to the outside, as shown in FIG. 1(b). Therefore, disadvantages arise in that it is difficult to perform a touch in areas near the boundary lines of the sheet 1′ and the boundary lines of the sheet 1′ hide the actual screen D. If the sheet 1′ is extended up to the rounded portions R, the adhesive layer 1a′ does not come into tight contact with the curved portions, and thus the sheet 1′ is torn off from the smartphone H.

Next, a bezel printing-type transparent sheet 1″ for the protection of a liquid crystal display has been developed as a second-generation sheet product for the protection of a liquid crystal display. A bezel H′ is the portion of a smartphone exclusive of a screen D, and is distinguished from the screen D by a border portion, such as a black line. As the bezel H′ decreases, the size of an actual screen increases, and concentration increases. When a border portion is sensitive to a touch, the problem in which the unwanted operation of a mobile phone is performed occurs, and thus it is difficult to completely eliminate the bezel H.′

For example, as shown in FIG. 2(a), the sheet 1″ is formed to include a bezel region 1c″ so that the sheet 1″ can cover not only the screen D of the smartphone H but also the bezel H.′ The bezel region 1c″ is formed to surround a center transparent portion by using a printing method.

The sheet 1“includes an adhesive layer 1a” and a cover sheet 1b,″ as shown in FIG. 2(b). The sheet 1″ covers a larger region than the sheet 1.′ However, the bezel region 1c″ has the same plane integrated with and extending from the center portion of the sheet 1″ as the center portion, and thus a disadvantage still remains in that the sheet 1″ does not come into tight contact with the curved surface portions of the corners and rounded portions R of the smartphone H and is still torn off from the smartphone H.′

In order to remedy such a tearing-off phenomenon, the width of the bezel region 1c″ may be formed to be slightly wider than that of the bezel H.′ However, in this case, the quality of printing of the bezel region 1c″ may be lower than the quality of printing of the bezel H′ of the original smartphone H, and thus an aesthetically pleasing appearance may be degraded. Furthermore, an impression in which the region of a bezel exclusive of the screen D seems to be larger than the actual region thereof is given, and thus the marketability of the smartphone H is degraded.

Next, related patent documents are discussed. Korean Patent No. 10-1647004 discloses a detachable sheet for the protection of a liquid crystal display, including: a transparent printed layer configured to include a line pattern region printed on reinforced glass and the bezel region of the bottom surface of the reinforced glass, and a depressed pattern region printed on the central portion of the bezel region of the bottom surface of the reinforced glass and formed to have depressions formed in a pattern form, and printed in transparent ink; a bezel printed layer coupled to the line pattern region, printed on the bottom surface of the bezel region of the reinforced glass, and printed in ink having a specific color; an OCA layer adhered to cover the depressed pattern region and the bezel printed layer; a film layer coupled to the OCA layer, and made of a light transmitting material; and an adhesive layer coupled to the film layer.

Furthermore, Korean Patent Application Publication No. 10-2017-000649 discloses an attachable sheet for the protection of a liquid crystal display, comprising: an OCA layer adhered to reinforced glass and the bottom surface of the reinforced glass; an adhesive layer formed on the bottom surface of the OCA layer; a printed layer printed on the central bezel region of the bottom surface of the reinforced glass; a grating-type printed pattern printed on the center region of the bottom surface of the reinforced glass in a grating form; a deposition layer deposited on the printed layer; and a film layer made of a light transmitting material.

However, the technologies disclosed in these documents are disadvantageous in that they do not overcome the disadvantages of the above-described bezel printed-type sheet 1,′ and are also disadvantageous in that they have excessively large numbers of layers, and thus it is difficult to fabricate the sheets and the costs of the sheets are excessively high.

Furthermore, Korean Patent Application Publication No. 10-2016-0061078 discloses a protector for a portable electronic device, including a plane protection part 100′ configured to protect a plane part and a corner protection part 200′ configured to protect corner parts, as shown in FIG. 3. However, the corner protection part 200′ and the plane protection part 100′ are separate configurations, and are made of synthetic resin or metal. Accordingly, the protector can protect the screen of a liquid crystal display, but cannot completely cover rounded portions having fine curvatures.

### SUMMARY

The present invention has been conceived to overcome the above-described problems, and an object of the present disclosure is to provide a 3D sheet which can be closely attached to the screen and border portion, including rounded portions, of an electronic device, such as a smartphone.

In order to accomplish the above object, according to an embodiment of the present disclosure, there is provided a three-dimensional (3D) sheet configured to be attached to the screen of an electronic device and a border portion surrounding the screen, the 3D sheet including: an adhesive layer configured to be attached to the screen and border portion of the electronic device so that the adhesive layer covers 90% or more of the overall area of the front surface of the electronic device; and a cover sheet configured to be attached to the adhesive layer; wherein the adhesive layer includes an OCA layer, a PET film layer, and a silicon adhesive layer; and wherein the 3D sheet is closely attached to the screen and border portion of the electronic device.

The elastic modulus of the OCA layer may range from 3.5×10⁴ to 1.6×10⁵ MPa in the range from 0 to 30° C.

The OCA layer may be made of an acrylic monomer, and may have a thickness ranging from 180 to 350 μm.

The acrylic monomer may include 2-hydroxyethyl acrylate (2-HEA), isooctyl acrylate (IOA), and acryloyl morpholine (ACMO) as soft functional groups, and includes isobornyl methacrylate (IBOMA) as a hard functional group.

The content ratio of the soft functional groups may range from 75 to 92 wt % based on the overall acrylic monomer.

The content ratio of 2-HEA of the soft functional groups may range from 25 to 35 wt %, the content ratio of IOA thereof may range from 37 to 45 wt %, and the content ratio of ACMO thereof may range from 14 to 22 wt %.

The content ratio of the hard functional group may range from 8 to 25 wt % based on the overall acrylic monomer.

The thickness of the cover sheet may range from 50 to 500 μm, the thickness of the PET film layer may range from 12 to 50 μm, and the thickness of the silicon adhesive layer may range from 10 to 50 μm.

According to another embodiment of the present disclosure, there is provided a three-dimensional (3D) sheet configured to be attached to the screen of an electronic device and a border portion surrounding the screen, the 3D sheet including: an adhesive layer configured to be attached to the screen and border portion of the electronic device so that the adhesive layer covers 90% or more of an overall area of a front surface of the electronic device, that is, a substantially overall area, within a range which does not cause interference with an external case of the electronic device, and a cover sheet configured to be attached to the adhesive layer; wherein the adhesive layer includes a flat plate portion configured to cover the screen of the electronic device, and a reinforced portion configured to cover at least part of the border portion; wherein the cover sheet includes a cover flat plate portion configured to be correspondingly attached to the flat plate portion of the adhesive layer and a cover reinforced portion configured to be correspondingly attached to the reinforced portion of the adhesive layer; wherein the adhesive layer includes an OCA layer, a PET film layer, and a silicon adhesive layer; and wherein the 3D sheet is closely attached to the screen and border portion of the electronic device.

The elastic modulus of the OCA layer may range from 3.5×10⁴ to 1.6×10⁵ MPa in the range from 0 to 30° C., and the thickness of the OCA layer may range from 180 to 350 μm.

The OCA layer may include 2-hydroxyethyl acrylate (2-HEA), isooctyl acrylate (IOA), and acryloyl morpholine (ACMO) as soft functional groups, and may include isobornyl methacrylate (IBOMA) as a hard functional group.

According to another embodiment of the present disclosure, there is provided an electronic device to which the 3D sheet is attached.

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are views showing a state in which a first-generation sheet product for the protection of a liquid crystal display, i.e., a conventional transparent sheet, has been attached to a smartphone;

FIGS. 2a and 2b are views showing a state in which a second-generation sheet product for the protection of a liquid crystal display, i.e., a conventional transparent sheet, has been attached to a smartphone;

FIG. 3 is a partial sectional view of a conventional protector for the protection of a mobile phone;

FIG. 4(a) is a perspective view showing a 3D sheet for the protection of an electronic device according to an embodiment of the present disclosure;

FIG. 4(b) is a sectional view showing a state in which the 3D sheet of FIG. 4(a) has been attached to a smartphone;

FIG. 5 is a sectional view showing a finished product of a 3D sheet for the protection of an electronic device according to an embodiment of the present disclosure;

FIG. 6 is a view showing a process of fabricating the adhesive layer of a 3D sheet for the protection of an electronic device according to an embodiment of the present disclosure;

FIG. 7 is a view showing a process of fabricating the adhesive layer of a 3D sheet for the protection of an electronic device according to another embodiment of the present disclosure;

FIG. 8 is a graph showing elastic moduluses measured while changing the component and content of an OCA layer according to the present disclosure;

FIGS. 9(a) and 9(b) show sectional views of states in which 3D sheets fabricated according to comparative examples have been attached to a smartphone; and

FIGS. 10(a) and 10(b) show sectional views of states in which 3D sheets fabricated according embodiments of the present disclosure have been attached to a smartphone, such as that of FIGS. 9(a) and 9b(b).

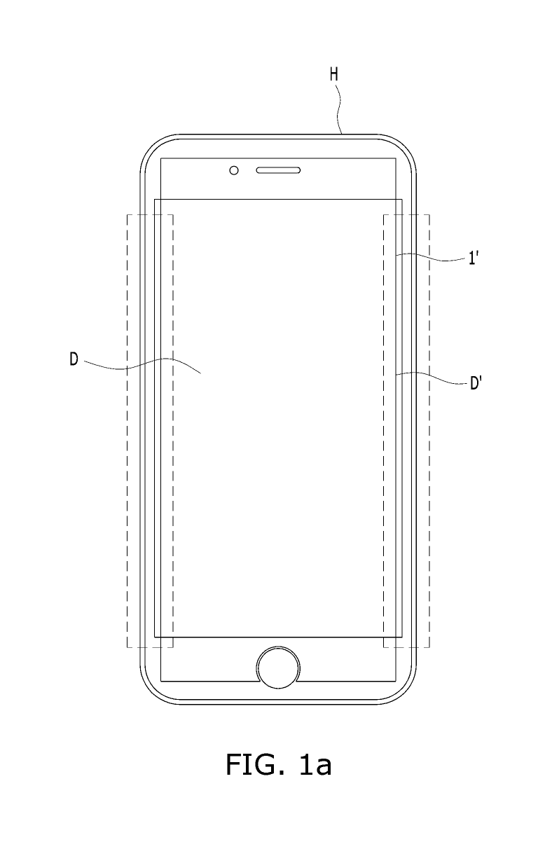

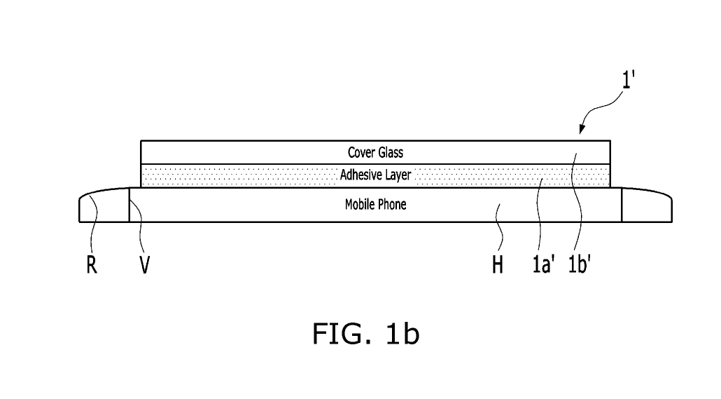

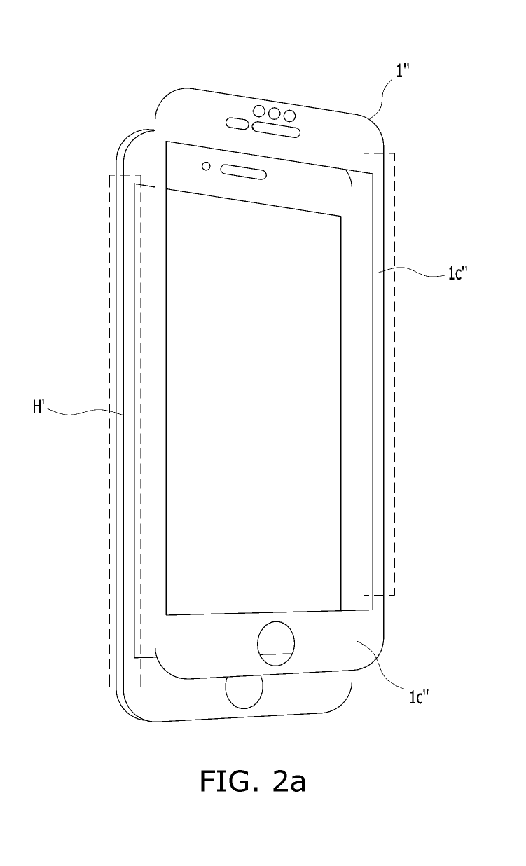

### DETAILED DESCRIPTION

Some embodiments of the present invention will be described in detail below with reference to the illustrative drawings. It should be noted that the same elements in the drawings are designated by the same reference symbols as far as possible even when they are shown in different drawings. Furthermore, in the following description of the present invention, when it is determined that a detailed description of a related well-known configuration or function may make the gist of the present invention obscure, the detailed description will be omitted.

In the following description of the components of the present invention, symbols, such as first, second, i), ii), (a), (b), etc., may be used. These are used merely to distinguish one component from another, and are not intended to limit the essentials, order or sequence of the components. Furthermore, throughout the specification and the claims, when any portion is described as “including” or “comprising” any component, this does not mean that the portion excludes another component, but means that the portion may include another component, unless otherwise clearly specified.

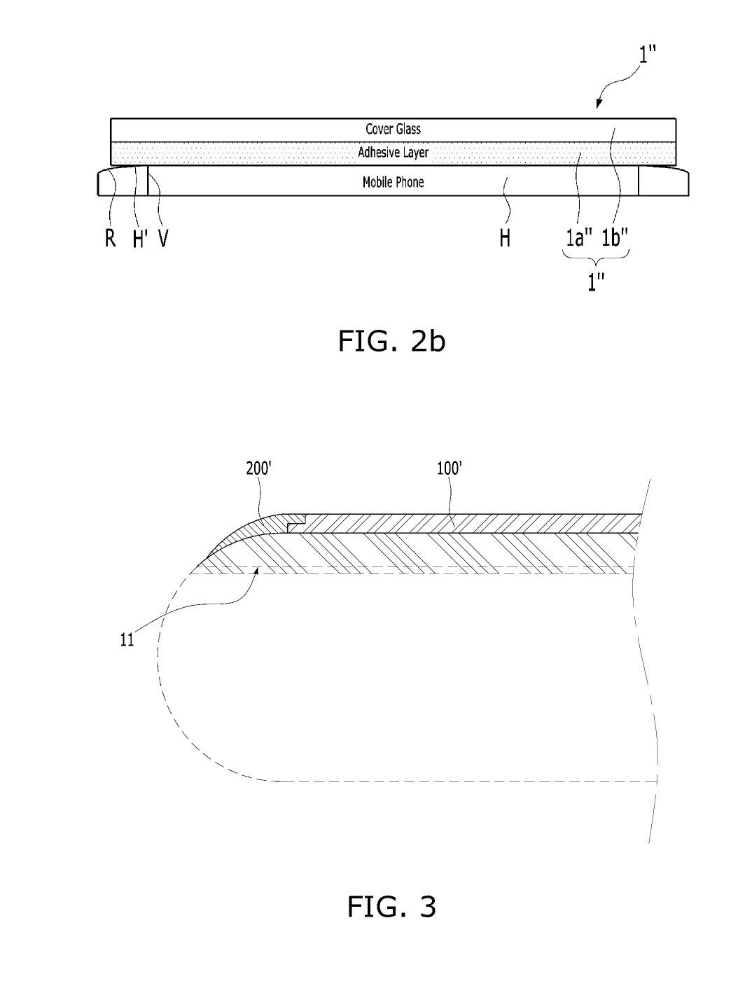

FIG. 4(a) is a perspective view showing a 3D sheet 1 for the protection of an electronic device according to an embodiment of the present invention. Although a mobile phone, such as a smartphone H, is representative of the electronic device, the electronic device includes all electronic devices portable and having a panel, such as a tablet PC, a PDA, a smart watch, etc.

The front surface of the smartphone H includes a screen D, and a border portion R provided in a bezel located outside the screen D. The border portion R includes rounded portions most of which are composed of curved surfaces. However, a rounded portion may not be present in part of corners and top and bottom surfaces.

The 3D sheet 1 according to the present disclosure is characterized by being a transparent sheet which closely and airtightly covers all of the screen D and the border portion R.

As shown in FIG. 4(b), the 3D sheet 1 includes an adhesive layer 1a configured to be attached to the front surface of the smartphone H and a cover sheet 2a configured to be attached to the top surface of the adhesive layer 1a.

In the side views below FIG. 4(b), boundary lines V indicate the region boundaries of the screen region V/A of a smartphone H when viewed from a side of the smartphone H.

The front surface of the smartphone H includes a flat screen D and a border portion R disposed outside the screen D. In this case, the adhesive layer 1a includes a flat plate portion 1b configured to cover the screen D of the smartphone H, and a reinforced portion 1c configured to cover at least part of the border portion R. The reinforced portion 1c covers the corners or edges of the smartphone H exclusive of the screen D of the smartphone H, and most of the corners or edges include rounded portions. In this sense, the “reinforced portion” according to the present disclosure may be referred to as a “corner portion,” “edge portion,” or “curved surface portion.”

The cover sheet 2a includes a cover flat plate portion 2a configured to be correspondingly attached to the flat plate portion 1b of the adhesive layer 1a, and a cover reinforced portion 2c configured to be correspondingly attached to the reinforced portion 1c of the adhesive layer 1a.

The 3D sheet 1 according to the present disclosure is attached not only to the screen D but also to at least part or all of the border portion R including rounded portions and is not torn off and separated from the smartphone H, as shown in FIG. 4(b). Accordingly, the 3D sheet 1 also covers the corners of a liquid crystal display, thereby providing a natural touch sensation in connection with the edge portion, and also preventing corner surfaces from being damaged. Furthermore, a screen hiding or image distortion phenomenon, which may occur due to the attachment of the sheet, can be completely prevented, and thus the intrinsic color or high-level design of a smartphone can be maintained without change.

When the 3D sheet 1 according to the present disclosure is attached to the commercialized smartphone H, the results of measuring the ratios of areas, to which the conventional 2D sheet 1 is attached, to overall areas including the smartphone screen D and the border portion R and the ratios of areas, to which the 3D sheet 1 is attached, to the overall areas are listed in Table 1. The conventional 2D sheets are based on unprinted transparent sheets.

TABLE 1

| Type | 2D sheet | 3D sheet |
|---|---|---|
| iPhone 7 | 88% | 96% |
| iPhone 7 Plus | 88% | 96% |
| Galaxy S8 | 83% | 93% |
| Galaxy S8 Plus | 83% | 93% |

As described above, the 3D sheet 1 according to the present disclosure is characterized by being tightly and closely attached to the screen D and border portion R of the smartphone H and maximally covering at least 90% of the region of the front surface of the smartphone H. Although a maximum of 100% may be possible, a margin is determined by considering a range within which interference with the external case of an electronic device does not occur.

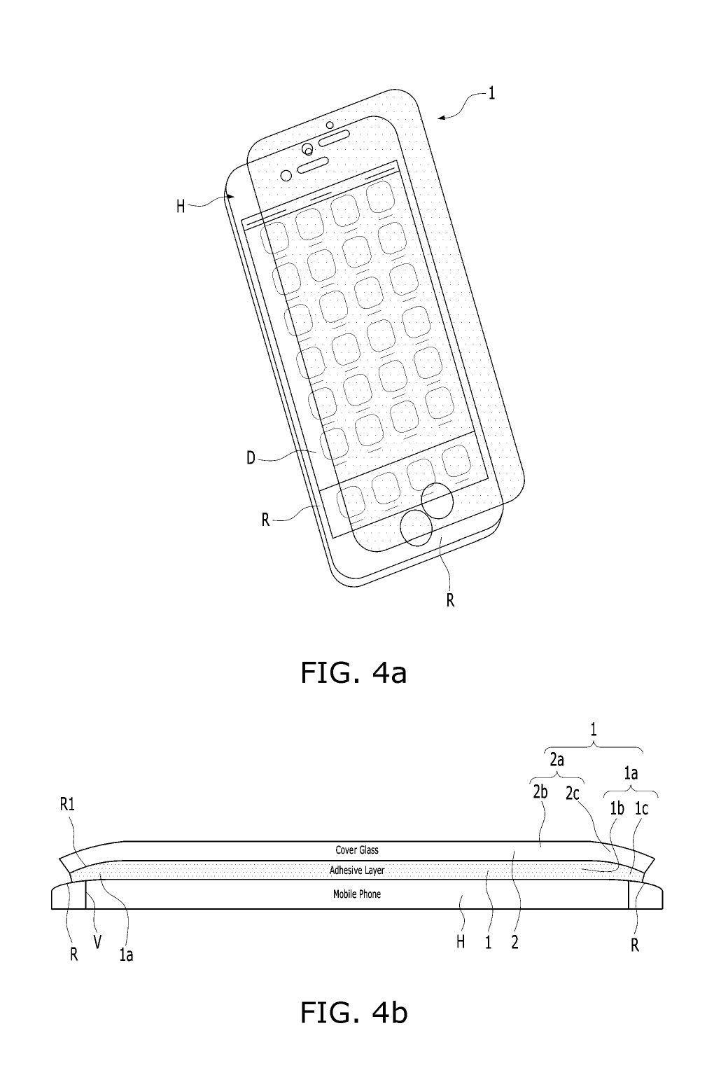

FIG. 5 is a sectional view showing a finished product of a 3D sheet 1 for the protection of an electronic device according to an embodiment of the present disclosure. The 3D sheet 1 includes four layers, and does not include a complex structure having five or more layers, unlike the conventional technology.

The cover sheet 2a functions to protect the surface of a mobile phone and to prevent the mobile phone from being damaged. The thickness of the cover sheet 2a preferably ranges from 50 to 500 μm. For example, a glass layer formed by performing ion reinforcement treatment on aluminosilicate glass may be used as the material of the cover sheet. In addition to the glass layer, plastic resin, such as acryl, PC, PMMA, etc., may be used as the material of the cover sheet 2a.

The adhesive layer 1a of the 3D sheet 1 includes an optical clear adhesive (OCA) layer 10, a PET film layer 12, and a silicon adhesive layer 14 sequentially from the top.

The OCA layer 10 is obtained by curing a highly transparent acrylic monomer via an ultraviolet (UV) process. The acrylic monomer constituting the OCA layer 10 includes a monomer having soft functional groups and a monomer having a hard functional group. The thickness of the OCA layer 10 preferably ranges from 180 to 350 μm.

The acrylic monomer according to the present invention includes 2-hydroxyethyl acrylate (2-HEA), isooctyl acrylate (IOA), and acryloyl morpholine (ACMO) as the soft functional groups.

2-HEA and IOA have low glass transition temperatures, and thus 2-HEA and IOA aid in the softening of the OCA layer 10 and increase an elastic modulus.

ACMO has a high viscosity and a high degree of cure, and thus ACMO may be used as diluent in a UV curing process, has significantly high elastic force, and has desirable heat resistance.

Since IOA is softer and has a higher unit cost than ACMO and ACMO is harder and has a lower unit cost than IOA, two types of components are appropriately combined and then used.

The content ratio of the soft functional groups to the overall acrylic monomer preferably ranges from 75 to 92 wt %. More specifically, the content ratio of 2-HEA preferably ranges from 25 to 35 wt %, the content ratio of IOA preferably ranges from 37 to 45 wt %, and the content ratio of ACMO preferably ranges from 14 to 22 wt %.

The OCA layer 10 according to the present invention may further include, for example, isobornyl methacrylate (IBOMA) as the hard functional group. However, IBMA has a high glass transition temperature, and thus an elastic modulus may be decreased by increasing the toughness of the adhesive layer. Accordingly, the mixing ratio thereof to the overall acrylic monomer is preferably limited to the range from 8 to 25 wt %. When IBOMA is not added, a problem with heat resistance occurs. Accordingly, it is preferable to satisfy a minimum content condition within a range within which the above problem does not occurs.

The PET film layer 12 may be made of any conventional material as long as the material has high tensile strength, desirable heat resistance, desirable insulation, desirable moisture resistance, desirable water resistance, and desirable transparency. The thickness of the PET film layer 12 preferably ranges from 12 to 50 μm. The PET film layer 12 is interposed between the OCA layer 10 and the silicon adhesive layer 14 and adhered to the two layers, and thus functions to perform integration into a single product.

The silicon adhesive layer 14 functions to adhere the adhesive layer 1a to the smartphone H, and may be used for any conventional product. The thickness of the silicon adhesive layer 14 preferably ranges from 10 to 50 μm.

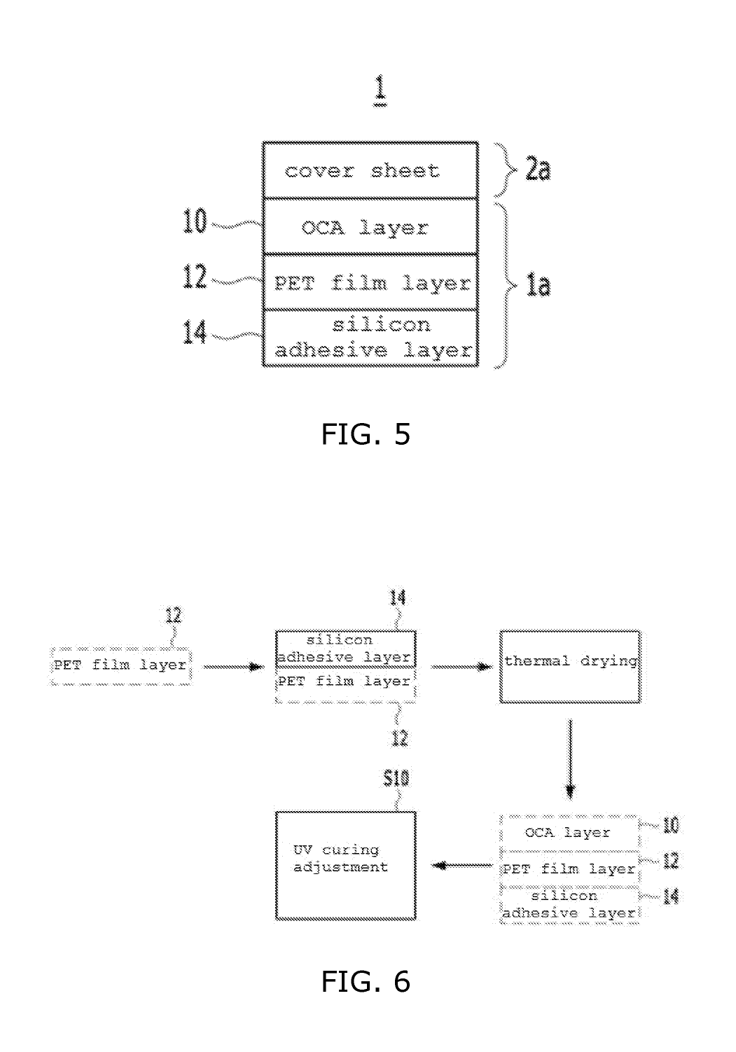

FIG. 6 is a view showing a process of fabricating the adhesive layer 1a of a 3D sheet 1 for the protection of an electronic device according to an embodiment of the present disclosure.

First, a PET film layer 12 is prepared.

The silicon adhesive layer 14 is adhered to the PET film layer 12, and then the silicon adhesive layer 14 and the PET film layer 12 are integrated together via a thermal drying process.

After the thermal drying process, an OCA layer 10 is adhered to the PET film layer 12, and is then subjected to a UV curing process.

Alternatively, after the OCA layer 10 is attached to the PET film layer 12, the silicon adhesive layer 14 may be adhered, may be subjected to a thermal drying process, and may be then subjected to a UV curing process.

In the UV curing process, a method of adjusting the degree of cure is to adjust the time for which UV light is radiated, to adjust the angle at which UV light is radiated, etc. In an embodiment of the present disclosure, the degree of cure is adjusted using the energy of UV light.

When a lamp emitting an UV-A wavelength ranging from 315 to 420 nm, for example, a mercury lamp, a metal lamp, a gallium lamp, or a xenon lamp, is used, an energy ranging from 1200 to 1700 mJ is required to cure 100% of the adhesive layer 1a. Furthermore, an energy ranging from 500 to 900 mJ 90% is required to cure the adhesive layer 1a, and an energy ranging from 400 to 500 mJ is required to cure 85% of the adhesive layer 1a.

The degree of cure is preferably selected in accordance with a final physical property, particularly an elastic modulus, of the adhesive layer 1a. When the wavelength of UV-B or UV-C is used, a parameter, such as the time for which a UV ray is radiated, may be adjusted in accordance with the energy range based on the degree of cure.

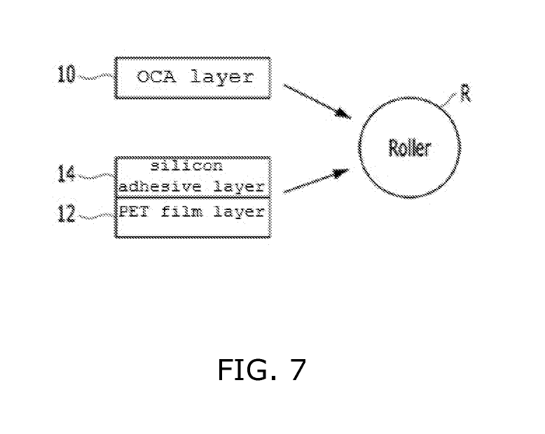

FIG. 7 is a view showing a process of fabricating the adhesive layer 1a of a 3D sheet 1 for the protection of an electronic device according to another embodiment of the present disclosure.

An OCA layer 10 is separately prepared, a PET film layer 12 is attached to a silicon adhesive layer 14, and the two layers are struck together by supplying the two layers into rollers R, thereby completing the adhesive layer 1a. Any well-known method may be employed as a process of sticking the two layers together using the rollers R.

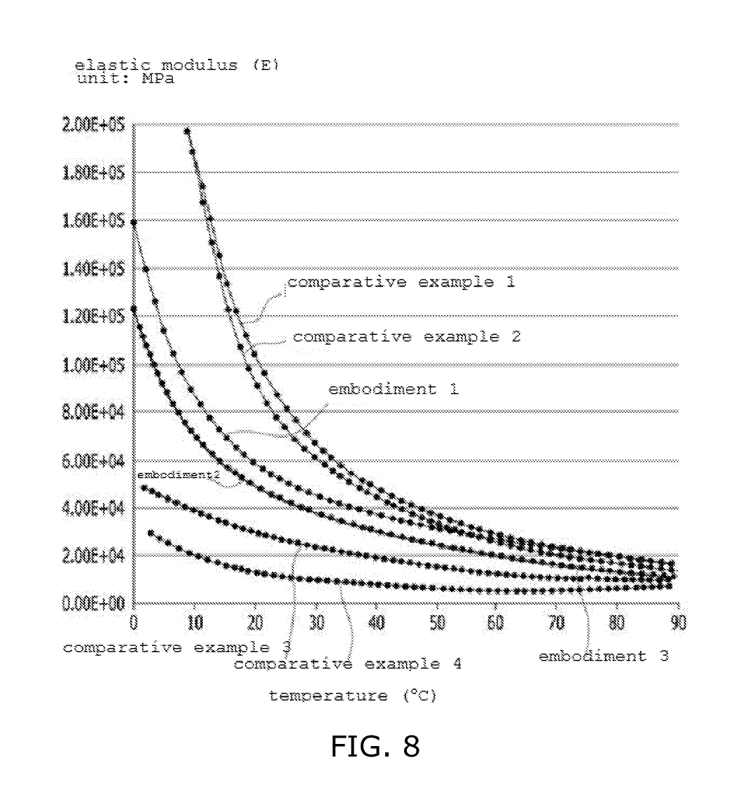

FIG. 8 is a graph showing elastic moduluses measured while changing the component and content of the OCA layer 10 according to the present disclosure. The x-axis represents temperatures, and the y-axis represents elastic moduluses (unit: MPa). Specimens were fabricated by forming the OCA layer 10, stacked to a thickness of 1 mm, to have a diameter of 20 mm, and elastic moduluses were measured in the range from 0 to 90° C. while applying vibrations having a frequency of 1 Hz by using AR-2 (manufactured by the Texas Instrument company).

The components and contents of embodiments 1, 2 and 3 and comparative examples 1, 2, 3 and 4 are listed in Table 2 below:

TABLE 2

| Type | 2-HEA | IOA | ACMO | IBOMA |
|---|---|---|---|---|
| Embodiment 1 | 35 | 37 | 18 | 8 |
| Embodiment 2 | 30 | 45 | 15 | 10 |
| Embodiment 3 | 27 | 43 | 17 | 13 |
| Comparative example 1 | 30 | 50 | 15 | 5 |
| Comparative example 2 | 30 | 40 | 25 | 5 |
| Comparative example 3 | 25 | 37 | 10 | 28 |
| Comparative example 4 | 20 | 30 | 15 | 35 |

(content: wt % based on an overall acrylic monomer)

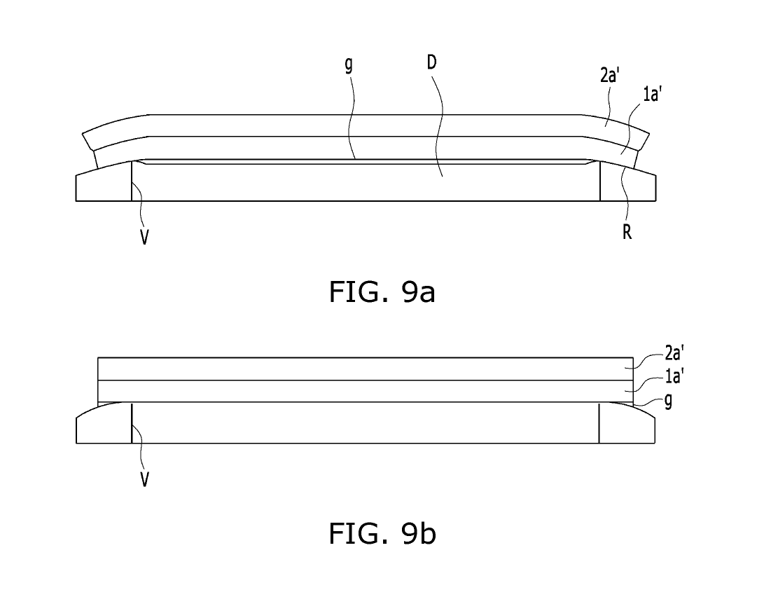

FIGS. 9(a) and 9(b) show sectional views of states in which 3D sheets fabricated according to comparative examples have been attached to a smartphone H.

FIG. 9(a) shows sectional views of 3D sheets fabricated according to comparative examples 1 and 2. They contain a large quantity of monomer having soft functional groups, and the content ratio of hard functional groups is low. Accordingly, although curvatures are assigned to an adhesive layer 1a′ and a cover sheet 2a′ in accordance with the border portions R of an electronic device, the center portion of the adhesive layer 1a′ is torn off in accordance with curvature portions, with the result that a problem arises in that gaps g occur.

FIG. 9(b) shows sectional views of 3D sheets fabricated according to comparative examples 3 and 4. They contain a small quantity of monomer having soft functional groups, and the content ratio of hard functional groups is high. Accordingly, it is difficult to assign curvatures to an adhesive layer 1a′ and a cover sheet 2a′ in accordance with the border portions R of an electronic device, with the result that a problem arises in that gaps g occur.

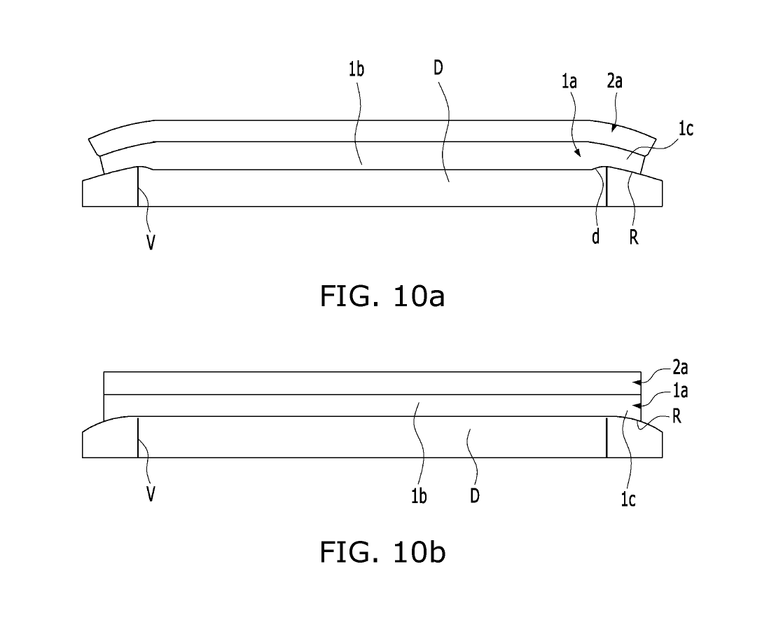

FIGS. 10(a) and 10(b) show sectional views of states in which 3D sheets 1 fabricated according embodiments of the present disclosure have been attached to a smartphone H, such as that of FIGS. 9(a) and 9(b).

In the case of FIG. 10(a), it can be seen that although stepped portions d are present in the boundaries between a screen D and border portions R, the 3D sheet 1 completely comes into tight contact with a smartphone H. In the case of FIG. 10(b), it can be seen that the 3D sheet 1 closely extends while forming a single surface along with a screen D and completely comes into tight contact with border portions R.

It can be seen that the effect of attaching the 3D sheet 1 according to an embodiment of the present disclosure has a close relationship with the elastic modulus of the OCA layer 10.

In other words, referring back to FIG. 8, the electronic device is used at room temperature, particularly in the range from 0 to 30° C. It can be seen that in this temperature range, the elastic modulus of the OCA layer 10 ranges from 3.5×104 to 1.6×105 MPa. It will be appreciated by those skilled in the art that the component and content ratio of the OCA layer 10 are not limited to those of the disclosed embodiments as long as they satisfy the elastic modulus range and that the component may be replaced with another component or another component may be added.

The present invention provides the 3D sheet which can be closely attached to the screen and border portion, including rounded portions of an electronic device, such as a smartphone, and thus the sheet can also cover the corner portions of a liquid crystal display, can provide a natural touch sensation in connection with edge portions, and can prevent corner surfaces from being damaged.

Furthermore, the present invention provides the effect of completely preventing a screen hiding or image distortion phenomenon, which may occur due to the attachment of a 3D sheet, from occurring, thereby maintaining the intrinsic color and high-level design of a smartphone without change.

Although the specific embodiments of the present invention have been described, this is merely illustrative, and does not limit the range of the rights of the present invention. It will be apparent to those skilled in the art that a change or an addition may be made to the disclosed embodiments of the present invention and this change or addition falls within the range of the rights of the present invention. It will be apparent that the range of the rights of the present invention includes ranges identical and equivalent to those of the attached claims.

1. A three-dimensional (3D) sheet configured to be attached to a screen of an electronic device and a border portion surrounding the screen, the 3D sheet comprising:
an adhesive layer configured to be attached to the screen and border portion of the electronic device so that the adhesive layer covers 90% or more of an overall area of a front surface of the electronic device; and
a cover sheet configured to be attached to the adhesive layer;
wherein the adhesive layer includes an OCA layer, a PET film layer, and a silicon adhesive layer; and
wherein the 3D sheet is closely attached to the screen and border portion of the electronic device.

2. The 3D sheet of claim 1, wherein an elastic modulus of the OCA layer ranges from 3.5×10⁴ to 1.6×10⁵ MPa in a range from 0 to 30° C.

3. The 3D sheet of claim 2, wherein the OCA layer is made of an acrylic monomer, and has a thickness ranging from 180 to 350 μm.

4. The 3D sheet of claim 3, wherein the acrylic monomer includes 2-hydroxyethyl acrylate (2-HEA), isooctyl acrylate (IOA), and acryloyl morpholine (ACMO) as soft functional groups, and includes isobornyl methacrylate (IBOMA) as a hard functional group.

5. The 3D sheet of claim 4, wherein a content ratio of the soft functional groups ranges from 75 to 92 wt % based on the overall acrylic monomer.

6. The 3D sheet of claim 5, wherein a content ratio of 2-HEA of the soft functional groups ranges from 25 to 35 wt %, a content ratio of IOA thereof ranges from 37 to 45 wt %, and a content ratio of ACMO thereof ranges from 14 to 22 wt %.

7. The 3D sheet of claim 6, wherein a content ratio of the hard functional group ranges from 8 to 25 wt % based on the overall acrylic monomer.

8. The 3D sheet of claim 7, wherein a thickness of the cover sheet ranges from 50 to 500 μm, a thickness of the PET film layer ranges from 12 to 50 μm, and a thickness of the silicon adhesive layer ranges from 10 to 50 μm.

9. A three-dimensional (3D) sheet configured to be attached to a screen of an electronic device and a border portion surrounding the screen, the 3D sheet comprising:
an adhesive layer configured to be attached to the screen and border portion of the electronic device so that the adhesive layer covers 90% or more of an overall area of a front surface of the electronic device, that is, a substantially overall area, within a range which does not cause interference with an external case of the electronic device, and a cover sheet configured to be attached to the adhesive layer;
wherein the adhesive layer includes a flat plate portion configured to cover the screen of the electronic device, and a reinforced portion configured to cover at least part of the border portion;
wherein the cover sheet includes a cover flat plate portion correspondingly attached to the flat plate portion of the adhesive layer and a cover reinforced portion correspondingly attached to the reinforced portion of the adhesive layer;
wherein the adhesive layer includes an OCA layer, a PET film layer, and a silicon adhesive layer; and
wherein the 3D sheet is closely attached to the screen and border portion of the electronic device.

10. The 3D sheet of claim 9, wherein an elastic modulus of the OCA layer ranges from 3.5×10⁴ to 1.6×10⁵ MPa in a range from 0 to 30° C., and a thickness of the OCA layer ranges from 180 to 350 μm.

11. The 3D sheet of claim 9, wherein the OCA layer includes 2-hydroxyethyl acrylate (2-HEA), isooctyl acrylate (IOA), and acryloyl morpholine (ACMO) as soft functional groups, and includes isobornyl methacrylate (IBOMA) as a hard functional group.

12. An electronic device to which the 3D sheet set forth claim 1 is attached.

13. The 3D sheet of claim 1, wherein a second PET film sheet and a second silicon adhesive layer are arranged under a lower surface of the silicon adhesive layer.
